(19) United States
(12) Patent Application Publication
(10) Pub. No.: US 2022/0076102 A1
(43) Pub. Date: Mar. 10, 2022

(54) METHOD AND APPARATUS FOR MANAGING NEURAL NETWORK MODELS

(71) Applicant: SAMSUNG ELECTRONICS CO., LTD., Suwon-si (KR)

(72) Inventors: Arun ABRAHAM, Bangalore (IN); Akshay PARASHAR, Bangalore (IN); Suhas P K, Bangalore (IN); Vikram Nelvoy RAJ END IRAN, Bangalore (IN)

(73) Assignee: SAMSUNG ELECTRONICS CO., LTD., Suwon-si (KR)

(21) Appl. No.: 17/417,189

(22) PCT Filed: Jun. 29, 2020
(86) PCT No.: PCT/KR2020/008486

§ 371 Date: Jun. 22, 2021

(30) Foreign Application Priority Data
Jun. 28, 2019 (IN) 201941025814

(51) Int. Cl. G06N 3/04

(52) U.S. Cl. CPC G06N 3/0454

(57) ABSTRACT

A method of managing deep neural network (DNN) models on a device is provided. The method includes extracting information associated with each of a plurality of DNN models, identifying, from the information, common information which is common across the plurality of DNN models, separating and storing the common information into a designated location in the device, and controlling at least one DNN model among the plurality of DNN models to access the common information.

### TECHNICAL FIELD

The disclosure relate to deployment or management of neural networks in a device, and more particularly to methods and apparatuese for managing neural network models based on redundancy in the structures of the neural network models.

### BACKGROUND ART

Applications that require/utilize deep learning methods are prevalent in embedded devices (such as, but not limited to, smart phones, Internet of Things (IoT) devices, Personal Computers (PCs), tablets, and so on). In order to employ deep learning methods for executing instructions of an application, Deep Neural Network (DNN) models need to be deployed in the embedded devices. Such deployment of DNN models allows users to install applications in personal devices.

Currently, a plurality of DNN models can be deployed in a device. The plurality of DNN models can be executed by different applications installed in the device. As the number of applications installed in the device increases, a greater number of DNN models need to be deployed in the device. When an application is launched or if an instruct ion pertaining to an application needs to be executed, a DNN model is loaded in the Central Processing Unit (CPU) or other processing units, if any, in the device. When the execution is completed, the DNN model is unloaded from the CPU or from the other processing units. If the device is having an application that can operate in multiple operating modes, different DNN models are loaded/unloaded when there is a mode switch.

### DISCLOSURE

### Technical Problem

The processes of loading and unloading the DNN models during application launch or mode switch can consume time, thereby degrading the latency performance of the device.

### Technical Solution

To address the above-noted technical problem, a method of managing deep neural network (DNN) models on a device is provided. The method includes extracting information associated with each of a plurality of DNN models, identifying, from the information, common information which is common across the plurality of DNN models, separating and storing the common information into a designated location in the device, and controlling at least one DNN model among the plurality of DNN models to access the common information.

### Advantageous Effects

During the processes of loading and unloading the DNN models during application launching or mode switching can be performed without consuming redundant time and thus, the proposed disclosure increases the performance of the device in launching applications or switching applications in the device.

### DESCRIPTION OF DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 is an example scenario depicting the loading and unloading of Deep Neural Network (DNN) models during the launch and mode switching of a camera application;

FIG. 2 depicts various units of a device configured to deploy DNN models in the device based on redundancy in the structures of the DNN models and dependency amongst the DNN models, according to embodiments of the disclosure;

FIG. 3A is a flowchart depicting a method for deploying DNN models in the device, based on redundancy in the structures of the DNN models and dependency amongst the DNN models, according to embodiments of the disclosure;

FIG. 3B is a flowchart 310 depicting a method for managing DNN models, according to embodiments of the disclosure;

FIG. 4 is an example depicting the identification of redundancy in two DNN models, according to embodiments of the disclosure;

FIG. 5 is an example depicting the generation of an optimized model data, indicating the redundant and non-redundant layers in the DNN models utilized by a camera application installed in the device, according to embodiments of the disclosure;

FIG. 6 is an example depicting the loading of DNN models in different processing units of the device, according to embodiments of the disclosure

FIG. 7 is an example depicting the generation of a model dependency graph, indicating dependencies between four DNN models that are utilized by the camera application installed in the device, according to embodiments of the disclosure;

FIG. 8 is a use case scenario depicting sequential execution of a detector DNN model and a classifier DNN model, for detecting objects and classifying the detected objects in a Region of Interest (ROI) of a media captured by the camera application, according to embodiments of the disclosure;

FIG. 9 is an example depicting preloading of DNN models in different processing units of the device by a model pre-loader, according to embodiments of the disclosure; and

FIG. 10A and FIG. 10B are a use case scenario depicting the preloading/loading/unloading of DNN models used by the camera application based on model dependency graph and optimized model data, according to embodiments of the disclosure.

### BEST MODE

To address the above-noted technical problem, a method of managing deep neural network (DNN) models on a device is provided. The method includes extracting information associated with each of a plurality of DNN models, identifying, from the information, common information which is common across the plurality of DNN models, separating and storing the common information into a designated location in the device, and controlling at least one DNN model among the plurality of DNN models to access the common information.

Accordingly, the embodiments provide methods and systems for deployment of Deep Neural Network (DNN) models in a device based on redundancy in the structures of the DNN models and dependency amongst the DNN models. The embodiments include identifying redundancies in the structures of the DNN models by comparing each of the DNN models with other DNN models. The embodiments include determining a reference count pertaining to each layer of each of the DNN models. The embodiments include traversing the layers of each of the DNN models and initializing the reference count value of each layer during the traversal. If it is determined that a layer of a DNN model is also present in another DNN model, then the reference count can be incremented. A layer of a DNN model can be identified as contributing to redundancy in the structure of the DNN model if the reference count corresponding to the layer of the DNN model is incremented, implying that the layer is present in at least two DNN models. The layers of the DNN models whose reference count values are not incremented are considered as unique. The portion of the structure of the DNN model where the unique layers fall can be categorized as specific area.

The embodiments include determining dependencies amongst the DNN models, wherein the dependencies indicate order of execution of the DNN models across a plurality of applications or within an application. The dependencies between at least two DNN models can be determined by ascertaining whether at least one application is executing the at least two DNN models in parallel, independently, or in a sequence. The loading and unloading of non-redundant layers of the DNN models in the device can be managed based on dependencies between the DNN models across the plurality of applications or within the application, and available memory in the device. If the DNN models are executed sequentially and if there is redundancy in the structures of the DNN models, the layers in the specific area of the DNN models can be loaded in sequence. Similarly, if the DNN models are executed in parallel and if there is redundancy in the structures of the DNN models, the layers in the specific areas of the DNN models can be loaded at the same time. If the DNN models are executed independently of one another, then there is no dependency between the DNN models. Consequently, loading and unloading of the layers of the DNN models is independently performed. The embodiments herein include preloading the layers of the DNN models based on the identified redundancies of the DNN models and dependencies among the DNN models across the plurality of applications or within the application.

### MODE FOR INVENTION

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates. Unless otherwise defined, all technical and scientific terms used herein have the same meaning as commonly understood by one of ordinary skilled in the art to which this disclosure belongs. The system, methods, and examples provided herein are illustrative only and not intended to be limiting.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching and illuminating some embodiments and their specific features and elements and does not limit, restrict or reduce the scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having ordinary skills in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should NOT be necessarily taken as limiting factors to the attached claims. The attached claims and their legal equivalents can be realized in the context of embodiments other than the ones used as illustrative examples in the description below.

Embodiments of the present disclosure will be described below in detail with reference to the accompanying drawings.

The processes of loading and unloading the DNN models during application launch or mode switch can consume time, thereby degrading the latency performance of the device. The loading and unloading of the DNN models can be skipped if the DNN modes are preloaded in the memory of the CPU/other processing units. If a large number of DNN models are employed by the applications installed in the device and if the memory requirement for keeping the DNN models preloaded in the CPU/other processing units is high, then preloading is likely to be restricted by the device.

The processes of loading and unloading of the plurality of DNN models during application launches, application exits, and mode switches within an application, can degrade the performance of the device. It may not be possible to preload all required DNN models due to the significant memory requirements of complex DNN models. Currently, there are methods used for optimizing memory usage by each DNN model. However, when multiple DNN models are used, a specific port ion of the memory needs to be reserved for storing each of the DNN models. This can limit the number of DNN models that can be used in a device. The other processing units in the device, such as Graphical Processing Unit (GPU), Digital Signal Processor (DSP), Neural Processing Unit (NPU), and so on, apart from the CPU, may not have sufficient memory to preload all the DNN models used by the applications in the device. Therefore, due to memory/performance constraints, the developers/designers of the applications are likely to deploy simpler models, which may not be able to enhance the performance of the device in terms of utilizing all the features of all the applications.

Currently, transfer learning (which is based on machine learning) is used for developing or creating new DNN models. In transfer learning, a DNN model developed for performing a first task can be reused to perform a second task. The original structure of the DNN also undergoes changes for “creating” the new DNN model. Initially (during transfer learning), a pre-trained DNN model, having a high accuracy, low complexity, and small size is identified. The pre-trained DNN model can be configured to perform the first task. Thereafter, the pre-trained model is trained using a new data-set, wherein there are minor differences between the new data-set and the data-test used for pre-training the DNN model. Once the training using the new data-set is completed, the DNN model is capable of performing the second task. The structure of the DNN model undergoes changes due to transfer learning. Using different data-sets to train the pre-detained DNN model can result in different new DNN models. The new DNN models can have similarity in their respective structures. Therefore, if there are a plurality of DNN models deployed in a device, and if each of the DNN models are having structural similarities with the other DNN models, then there will be unnecessary memory usage.

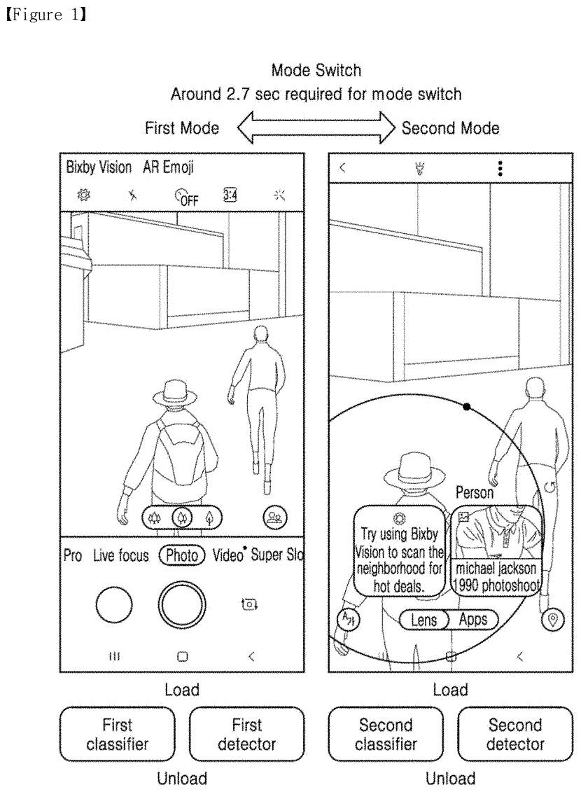

FIG. 1 is an example scenario depicting the loading and unloading of DNN models during the launch and mode switching of a camera application. according to an embodiment of the disclosure. Consider that the camera application is having two modes of operation, viz., a first mode and a second mode. As depicted in FIG. 1, consider that the first mode is used when the camera application is launched by a user. While operating in the first mode, two DNN models are used by the camera application. Consider that the DNN models are a first classifier and a first detector. The first detector can detect objects in the camera preview and the first classifier can classify the detected objects.

When the camera application operates in the first mode, the first classifier and the first detector are loaded on one the processing units (for example: GPU). In an example, the time taken to load the first classifier and the first detector on the GPU is approximately 2.7 seconds. When there is a mode switch, the camera application starts operating in the second mode (after switching from the first mode). After the mode switch (from the first mode to the second mode), the first classifier and the first detector are unloaded from the GPU and a second classifier (DNN model) and a second detector (DNN model) are loaded. The time taken for the loading the second classifier and the second detector and unloading of the first classifier and the first detector can be 2.7 seconds. When the mode is switched from the second mode to the first mode, the first classifier and the first detector are loaded after unloading the second classifier and a second detector. Therefore, the time taken for the process of loading and unloading the classifiers and the detectors (about 2.7 sec) degrades the performance of the device.

The latency performance degradation is due to memory constraints of the processing units, which restricts the preloading of the DNN models and also requires frequent loading and unloading. In an example, the models can be loaded at device boot time. In order to keep each model loaded on the processing units, a considerable amount of memory needs to be expedited, which is another constraint of the device. With advancement of devices, the number of models deployed in the devices is increasing. Most of the models have to be run on faster GPUs, DSPs, and NPUs. Even though the Random Access Memory (RAM) sizes of the devices have increased considerably, the amount of memory required to keep the DNN models preloaded on the processing units may not be sufficient.

As can be seen, deploying the DNN models directly on the embedded devices may present new challenges, as the DNN models leverage a significant computational complexity and memory requirements.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Embodiments herein disclose methods and systems for deployment of Deep Neural Network (DNN) models in a device by identifying redundancies in the structures of the DNN models in the device, and efficient preloading/loading/unloading of the layers of the DNN models based on dependency amongst the DNN models in the device. The embodiments include identifying redundancies in the structures of the DNN models by determining the layers that are present in multiple DNN models. The embodiments include determining a reference count values pertaining to all layers in all DNN models. The embodiments include traversing each layer of each of the DNN models and initializing the reference counts value pertaining to each of the layers. The embodiments include incrementing the reference count value pertaining to a layer in a DNN, if the layer is traversed more than once (in another DNN model). The embodiments include identifying a layer as a contributor of redundancy, if the reference count value pertaining to the layer has been incremented.

The embodiments include determining dependencies between the DNN models within an application or across a plurality of applications. The dependencies existing between at least two DNN models can be determined by ascertaining whether the at least two DNNs models are executed by at least one application at the same time, independently, or sequentially. The embodiments herein include preloading different layers of the DNN models based on the redundancies of the DNN models and dependencies of the DNN models across the plurality of applications or within the application.

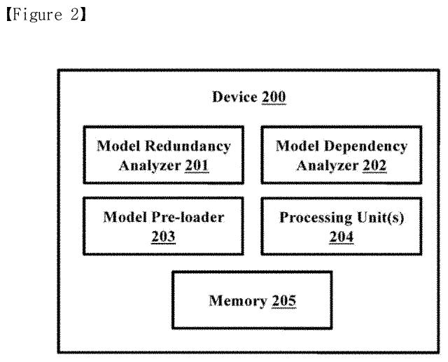

Referring now to the drawings, and more particularly to FIGS. 2 through 10, where similar reference characters denote corresponding features consistently throughout the figures, there are shown preferred embodiments.

FIG. 2 depicts various units of a device 200 configured to deploy DNN models in the device 200 based on redundancy in the structures of the DNN models and dependency amongst the DNN models, according to embodiments of the disclosure. As depicted in FIG. 2, the device 200 comprises a model redundancy analyzer 201, a model dependency analyzer 202, a model pre-loader 203, at least one processing unit 204, a memory 205, and a display 206. Examples of the device 200 include, but not limited to, a smart phone, a tablet, a laptop, a wearable device, a Personal Computer (PC), an Internet of Things (IoT) device, or any other embedded device. In an embodiment, the model redundancy analyzer 201, the model dependency analyzer 202, the model pre-loader 203, and the at least one processing unit 204 may be implemented as at least one hardware processor.

The at least one processing unit 204 includes at least one of a Central Processing Unit (CPU), a Graphical Processing Unit (GPU), a Digital Signal Processor (DSP) and a Neural Processing Unit (NPU). The memory 205 can store the DNN models that are loaded on, or unloaded from, the at least one processing unit 204. The memory 205 can store information pertaining to at least one of particulars of layers of the DNN models, structures of the DNN models, memory available in the at least one processing unit 204, redundancy between the DNN models and dependency amongst the DNN models. The information can be retrieved by at least one of the model redundancy analyzer 201, the model dependency analyzer 202 and the model pre-loader 203 to manage deployment of DNN models in the at least one processing unit 204.

A plurality of applications may be installed in the device 300 and one or more applications may utilize at least one DNN model to perform operations pertaining to the applications. Each DNN model includes multiple layers. The deployment of the DNN models comprises loading/preloading DNN models in the device 200 and unloading DNN models from the device 200. Efficient loading, unloading, and preloading can improve the memory usage efficiency and latency of the device 200.

The model redundancy analyzer 201 can identify redundancies in the structures (architectures) of the DNN models. In an embodiment, the model redundancy analyzer 201 can identify redundancies in the structures (architectures) of the DNN models by comparing each DNN model with the other DNN models. For example, if the device 200 includes five DNN models, the model redundancy analyzer 201 can compare each DNN model with the other four DNN models. The comparison involves determining a reference count pertaining to each layer of each of the DNN models. The model redundancy analyzer 201 can traverse each layer of each of the DNN models. When a layer of a DNN model is traversed for the first time, the model redundancy analyzer 201 can initialize the reference count value pertaining to the layer of the DNN model.

While traversing a first DNN model, if the model redundancy analyzer 201 determines that a layer in the first DNN model has already been traversed (for example: a second DNN model), the model redundancy analyzer 201 increments the reference count value pertaining to the layer in the first DNN model. In an embodiment, the model redundancy analyzer 201 determines that a layer of a DNN model has already been traversed or not, based on the particulars of that layer. In an example, the particulars comprise layer type such as convolution and other parameters such as kernel size, strides, padding, and so on.

If the particulars of a layer of the first DNN model is unique and does not match with the particulars of any other layer in any other DNN model that has already been traversed, the layer is considered as unique. On the other hand, if the particulars of the layer in the first DNN model matches with the particulars of a layer in the second DNN model, or any other DNN model, which has already been traversed, the layer in both the first and second DNN models, and the other DNN model(s), is considered as a contributor to the redundancy in the structures of the first DNN model, second DNN model, and the other DNN model(s). The model redundancy analyzer 201 can increment the reference count value pertaining to the layers that are contributing to the redundancy.

In an embodiment, the particulars of a layer include parameters pertaining to the layer, which can be the learned weights and bias values within operations. The structures of the DNN models can represent or include a combination of operations in networks. In an example, the structure includes a 3×3 convolution block, which is followed by a first Rectified Linear Unit (ReLU) operation block. The first ReLU operation block is followed by a 1×1 convolution block and a second ReLU operation block.

Once the reference count values pertaining to all the layers of all the DNN models have been determined, the structures of each of the DNN models is split into categories, viz., a common area and a specific area. In a DNN model, if at least one DNN model includes the layer in its structure, then the layer is considered to fall in the common area of the DNN model. Similarly, if the layer is a unique layer of the DNN model, then the layer falls in the specific area of the DNN model. The categorization allows determining the contributors of redundancy in the structures of the DNN models. The model redundancy analyzer 201 can generate an optimized model data, which is a tree, wherein the root node comprises of layers having the highest reference count. The layers in the succeeding levels have smaller reference count values. The leaf nodes comprise of layers having the lowest reference count values and represent the unique layers of the DNN models that fall in the specific areas of the structures of the respective DNN models.

The model dependency analyzer 202 can determine the dependencies amongst the DNN models that are to be deployed in the device 200. The dependency indicates the order in which the DNN models are executed by an application(s) and the order in which the different layers (especially layers in the specific areas of the respective DNN models) of the DNN models are loaded in, or unloaded from, the processing unit 204 for execution.

The dependencies amongst the DNN models can exist within an application, wherein at least two DNN models are executed by the application in sequence or in parallel. The dependencies can be across one or more applications, wherein at least two DNN models are executed by the respective applications in sequence or in parallel. If the at least two DNN models are run independently, then there is no dependency among the different DNN models.

The model dependency analyzer 202 generates a model dependency graph for depicting the dependencies amongst the DNN models. In an embodiment, the dependencies can be determined using information provided by the applications executing the DNN models. The information specifies whether the DNN models are in sequence, parallel or independently. The nodes of the model dependency graph represent the DNN models and edges connecting the nodes represent the order in which the DNN models are executed by an application(s). The types of edges connecting the nodes of the model dependency graph specify the order in which the DNN models are executed by the application(s). The types of edges specify whether the DNN models are supposed to be loaded at the same time or in sequence. In an embodiment, if there is a directed edge connecting two DNN models, the DNN model representing the source node (from which the directed edge originates) is executed first, and the DNN model representing the destination node is executed second. Thus, a directed edge specifies that the DNN models are executed in sequence. In another embodiment, if there is an undirected edge between the two DNN models, the DNN models connected by the undirected edge are executed in parallel. In yet another embodiment, if there are no edges between the two DNN models, then the DNN models are executed independent of each other. The model dependency graph can be used by the model pre-loader 203 to determine the layers of the DNN models that need to be preloaded.

The model pre-loader 203 preloads layers of the DNN models based on the redundancies in the structures of the DNN models and dependencies amongst the DNN models across the plurality of applications or within the application. The model pre-loader 203 retrieves the optimized model data, the model dependency graph, and available memory in the at least one processing unit 204 for preloading the layers of the DNN models. The preloading decreases the latency. The model pre-loader 203 ensures that layers in the common areas are not preloaded multiple times.

In an embodiment, the layers of the DNN models contributing to redundancy can be pre-loaded. The layers of the DNN models contributing to redundancy can be assigned priorities, based on the reference count values pertaining to the layers. If the reference count value pertaining to a layer in a DNN model is high, the assigned priority is high. Similarly, if the reference count value pertaining to a layer in a DNN model is low, the assigned priority is low. Based on the priorities of the layers of the DNN models that are contributing to the redundancy can be pre-loaded in the at least one processing unit 204.

Based on the model dependency graph, optimized model data, and available memory in the at least one processing unit 204, the model pre-loader 203 can determine the layers of the DNN models that are to be loaded or unloaded based on the memory available in the at least one processing unit 204. The model pre-loader 203 can load/unload parts (common areas and/or specific area) of the structures of the DNN models in the memory of the at least one processing unit 204. The model pre-loader 203 can determine the parts of the structures of the DNN models to be kept loaded/unloaded when a DNN model is unloaded/loaded based on the memory shared by the at least one processing unit 204.

FIG. 2 shows exemplary units of the device 200, but it is to be understood that other embodiments are not limited thereon. In other embodiments, the device 200 may include less or more number of units. Further, the labels or names of the units are used only for illustrative purpose and does not limit the scope of the embodiments. One or more components can be combined together to perform same or substantially similar function in the device 200.

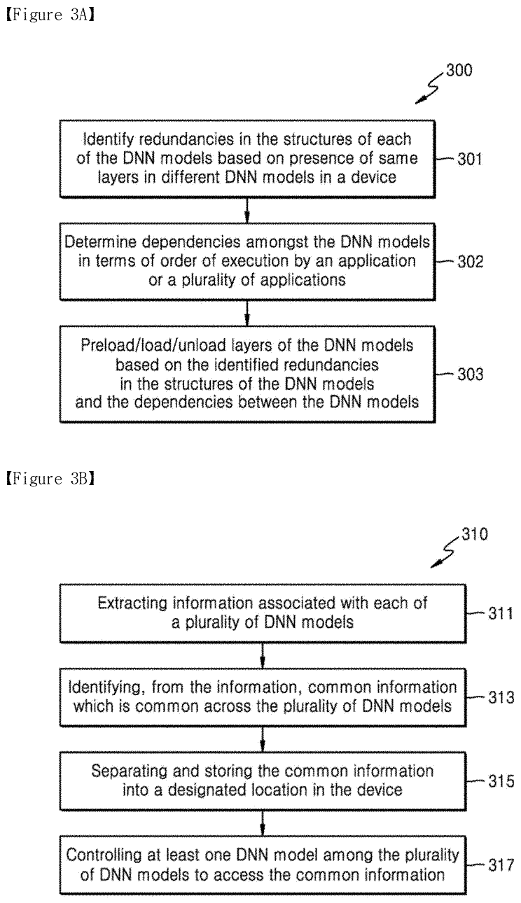

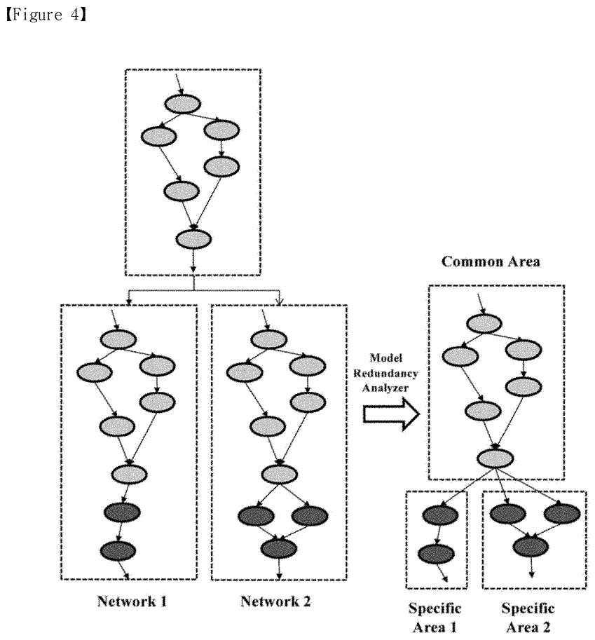

FIG. 3A is a flowchart 300 depicting a method for deploying DNN models in the device 200, based on redundancy in the structures of the DNN models and dependency amongst the DNN models, according to embodiments of the disclosure. At step 301, the method includes identifying redundancies in the structures of each of the DNN models based on presence of identical layers indifferent DNN models in the device 200. In an embodiment, each DNN model can be compared with the other DNN models by determining reference count values pertaining to all layers of each of the DNN models and comparing the reference count values.

The embodiments include traversing the layers of the DNN models and initializing the reference count values pertaining to the layers of the DNN models when the layers of the DNN models are traversed for the first time. The reference count values pertaining to the layers of the DNN models are incremented, if, while traversing the different DNN models, it is determined that the layers of the DNN models have been traversed previously. The embodiments include determining that a layer of a DNN model has already been traversed or not, based on the particulars of that layer. The embodiments include identifying that the layers of the DNN models are contributing to the redundancy if the reference count value pertaining to the layers of the DNN models is incremented.

Based on the reference count values pertaining to all the layers of all the DNN models, the embodiments include categorizing the structures of the DNN models into two categories, viz., a common area and a specific area. The layers that fall in the common area of the DNN model contribute to redundancy. The layers that fall in the specific areas of the DNN models are unique to the DNN model. The embodiments include generating an optimized model data that depicts the reference count values of the layers of different DNN modes. In an embodiment, the optimized model data is a tree, wherein the layers in the root node have the highest reference count. The leaf nodes of the tree comprise of layers having the lowest reference count values and represent the unique layers in the respective DNN models.

At step 302, the method includes determining the dependencies amongst the DNN models in terms of order of execution by an application or a plurality of applications. The embodiments include determining the dependencies amongst the DNN models for ascertaining the order in which specific DNN models are executed by the application/the plurality of applications. The order specifies the order in which the different layers of the DNN models are to be loaded for execution by the at least one processing unit 204 and the order in which the different layers of the DNN models are to be unloaded from the at least one processing unit 204 after completion of execution.

Based on the dependencies amongst the DNN models, the embodiments include determining whether at least two DNN models are executed by an application in sequence or in parallel. If the at least two DNN models are executed in sequence, the loading (or unloading if sufficient memory is not available in the at least one processing unit 204) of the at least two DNN models follows the sequence of execution. If the at least two DNN models are executed in parallel then the at least two DNN models are loaded at the same time, wherein multiple loading of layers in the common areas of the at least two DNN layers is avoided. If the at least two DNN models are run independently, then there is no dependency among the different DNN models.

The embodiments include generating a model dependency graph for depicting the dependencies amongst the DNN models. The nodes of the model dependency graph represent the DNN models and edges connecting the nodes represent the order in which the DNN models are executed. The types of edges connecting the nodes of the model dependency graph specify the order in which the DNN models are executed. If there is a directed edge connecting two DNN models, the DNN model representing the source node is executed first, and the DNN model representing the destination node is executed second. If there is an undirected edge between the two DNN models, the DNN models connected by the undirected edge are executed in parallel.

At step 303, the method includes preloading, loading, and unloading, the layers of the DNN models based on the identified redundancies in the structures of the DNN models and the dependencies between the DNN models. The embodiments include assigning priorities to the layers of the DNN models contributing to redundancy based on the reference count values pertaining to the layers of the DNN models. The priorities assigned to the layers of the DNN models are directly proportional to the reference count values pertaining to the layers in a DNN model. The embodiments include pre-loading the layers of the DNN models in the at least one processing unit 204, wherein the pre-loaded layers contribute to the redundancy of the structures of the DNN models, based on the assigned priorities. The embodiments set the priorities, as the at least one processing unit 204 may not have sufficient memory to keep all the layers of all the DNN models preloaded at all times.

The embodiments include determining the layers of the DNN models that are to be loaded or unloaded based on the memory available—the availability of capacity of the memory determined by the at least one processing unit 204. The embodiments include loading the layers in the common areas and/or specific areas of the structures of the DNN models in the memory of the at least one processing unit 204. The embodiments include unloading the layers in the common areas and/or specific areas of the structures of the DNN models if the memory of the at least one processing unit 204 is not sufficient. The embodiments include determining the parts of the structures of the DNN models to be kept loaded/unloaded when a DNN model is unloaded/loaded based on the memory shared by the at least one processing unit 204.

In an embodiment, the aforementioned method may be performed by a processing unit 204 of the device 200.

The various actions in the flowchart 300 may be performed in the order presented, in a different order, or simultaneously. Further, in some embodiments, some actions listed in FIG. 3 may be omitted.

FIG. 3B is a flowchart 310 depicting a method for managing DNN models, according to embodiments of the disclosure.

Referring to FIG. 3B, the processing unit 204 may extract information associated with each of a plurality of DNN models at step 311. The information associated with each of the plurality of DNN models may include parameters and structures of each of the plurality of DNN models. The parameters which are related to the layer, can be the learned weights and bias values within operations performed within the device.

At step 313, the processing unit 204 may identify, from the information, common information which is common across the plurality of DNN models.

At step 315, the processing unit 204 may separate and store the common information into a designated location in the device.

At step 317, the processing unit 204 may control at least one DNN model among the plurality of DNN models to access the common information. In an embodiment, the processing unit 204 may pre-load a subset of the common information based on a pre-loadable memory capacity of the device.

In an embodiment, the processing unit 204 may determine, among the plurality of DNN models, dependent models associated with each application installed on the device. The dependent models may include at least one of a model required to run with another model among the plurality of DNN models at the same time and a model with a fixed order of execution in relation to another model among the plurality of DNN models. The model with the fixed order of execution in relation to another model among the plurality of DNN models may include at least one of a model to be executed serially in relation to another model among the plurality of DNN models and a model to be executed in parallel with another model among the plurality of DNN models.

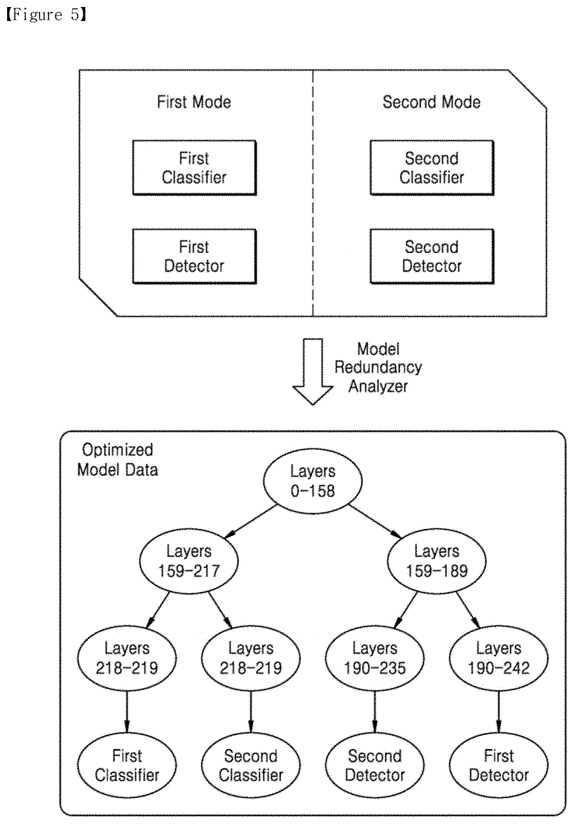

FIG. 4 is an example depicting the identification of redundancy in two DNN models, according to embodiments of the disclosure. As depicted in FIG. 4, consider that there are two DNNs to be deployed on the device 200, viz., network 1 and network 2. Consider that network 1 and network 2 have been obtained through transfer learning, wherein a pre-trained DNN model is trained using different data-sets to obtain the DNN models, network 1 and network 2. Therefore, network 1 and network 2 are likely to have structural similarities, which contribute to the redundancy in the structures of network 1 and network 2. The nodes of network 1 and network 2 represent the layers of the DNN models.

The model redundancy analyzer 201 can traverse the layers of the network 1 and the network 2 to determine the layers that are present in both DNNs, i.e., the network 1 and the network 2. The layers that are present in (part of) both the network 1 and the network 2 are identified as contributing to redundancy. Consider that the model redundancy analyzer 201 traverses the layers of the network 1 first, followed by the layers of the network 2. When a particular layer is traversed for the first time, the model redundancy analyzer 201 initializes a reference count pertaining to the particular layer. Considering the model redundancy analyzer 201 is traversing the network 1 for the first time, all the layers of network 1 are initialized during the traversal.

Once the traversal of network 1 has been completed, the model redundancy analyzer 201 can start traversing the layers of network 2. The model redundancy analyzer 201 can increment the reference count values pertaining to those layers that are present in both networks 1 and 2. The model redundancy analyzer 201 can increment the reference count values on determining that those layers are the same, based on parameters pertaining to the layers and the weight of the layers. The reference count values pertaining to the rest of the layers of network 2 are initialized. The layers whose associated reference count has been incremented are identified as contributing to redundancy (labeled as green).

Thereafter, based on the reference count values, the structures of network 1 and network 2 are categorized to generate an optimized model data. The structures are categorized into a common area (contributing to redundancy) and specific areas (non-redundant). Classifying the structure of the networks (DNN models) as one of the common area and the specific area allows optimal utilization of storage of the device 200. The embodiments prevent redundant storage of data and independence from particular chipset or processor. The model redundancy analyzer 201 allows the networks to be deployed on any chipset or processing unit.

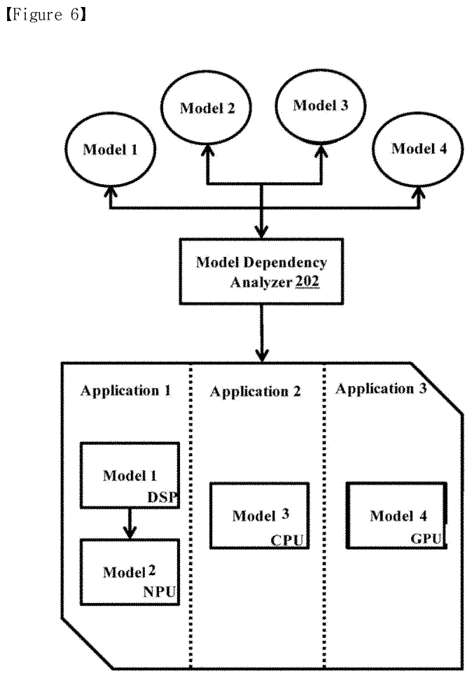

FIG. 5 is an example depicting the generation of an optimized model data, indicating the redundant and non-redundant layers in four DNN models that are utilized by a camera application installed in the device 200, according to embodiments of the disclosure. The camera application can operate in two modes, viz., a first mode and a version mode. When the camera application operates in the first mode, a first classifier and a first detector are executed. When the camera application operates in the second mode, a second classifier and a second detector are executed. The user can switch operating modes while using the camera application and consequently the relevant classifier and detector are executed.

The model redundancy analyzer 201 can traverse the layers of the first classifier, first detector, the second classifier and the second detector to determine the layers that are present in all four DNN models. The layers that are present in at least two DNN models can be considered to be contributing to redundancy in the structures of the first classifier, the first detector, the second classifier and the second detector. The layers that fall in the specific areas of the structures of the first classifier, the first detector, the second classifier and the second detector are the unique layers.

As depicted in FIG. 5, consider that there are 242 layers in the first classifier, the first detector, the second classifier and the second detector. The optimized model data is represented in a tree, wherein the layers with a higher reference count act as a parent to the layers with lower reference count(s). The layers at the leaf nodes are the unique layers in the respective DNN models.

Consider that layers 0-158 are present in the first classifier, the first detector, the second classifier and the second detector. These layers contribute to redundancy in the structures of the four DNNs. Each of the layers 0-158 is having a reference count of 4, as the layers 0-158 are present in the first classifier, the first detector, the second classifier and the second detector. The layers 159-217 are present in the first classifier and the second classifier. The layers 159-217 have a reference count of 2. The layers 159-189 are present in the first detector and the second detector. The layers 159-189 are having a reference count of 2. The remaining layers are non-redundant are unique to the respective DNN models. The layers 218-219 are unique to the first classifier, layers 218-219 are unique to the second classifier, layers 190-235 are unique to the second detector, and layers 190-242 are unique to the first detector. The unique layers have a reference count of 1 and are the leaf nodes.

It can be noted that 159-189 are present in first classifier, the first detector, the second classifier and the second detector. The layers 218-219 are present in the first classifier and the second classifier. The layers 190-235 are present in the first detector and the second detector. However, the content in these layers are different and hence are not considered to be identical. If these layers were considered to be identical, then the reference count values pertaining to these layers would have been incremented and be placed in the parent level node (relative to the current level).

The first classifier, the first detector, the second classifier and the second detector thus share their respective structures as there are layers in the common area. The first classifier and the second classifier share 90% structure, i.e., 90% of the layers of the first classifier are present in the second classifier. The first detector and the second detector share 70% structure, i.e., 70% of the layers of the first detector are present in the second classifier. The model redundancy analyzer 201 allows retraining the structure with a new dataset. If the layers of the first classifier have been loaded and the user performs a mode switch, which requires loading the second classifier, then the embodiments need not load the whole structure of the second classifier. Instead only 10% of the layers that are unique to the second classifier need to be loaded. Thus, the layers in the common area (layers that are not present in the leaf nodes) need not be loaded when the DNN model is run. If a previously loaded DNN model shares the structure with the currently executed DNN model, then only the unique layers of the DNN model needs to be loaded. Therefore, the optimized model data allows visualizing the redundancy in the structures of the DNN modes, which can be used for efficient preloading.

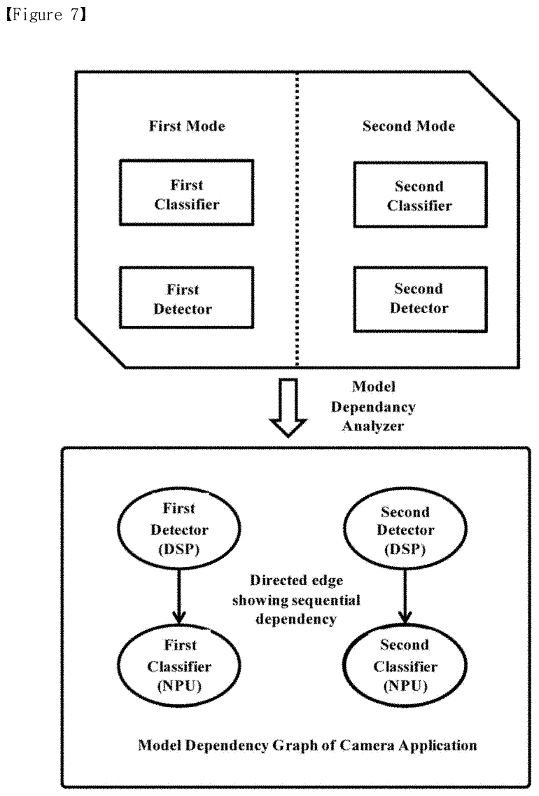

FIG. 6 is an example depicting the loading of DNN models in different processing units of the device 200, according to embodiments of the disclosure. Consider that the four DNN models, viz., model 1, model 2, model 3, and model 4, are executed by three applications (application 1, application 2, and application 3) installed in the device 200. Consider that application 1 executes models 1 and 2, application 2 executes model 3, and application 3 executes model 4. The device 200 includes four processing units, viz., DSP, NPU, CPU, and GPU. The loading of the DNN models on the memories of the four processing units and is further based on the model dependency graph.

The model dependency graph depicts dependencies amongst the DNN models based on the type of edges connecting the nodes (DNN models) of the model dependency graph. The edges of the model dependency graph specify whether the DNN models are supposed to be loaded parallelly or in sequence. If there is a directed edge between the two DNN models, then the DNN models are executed in sequence. As depicted in the example in FIG. 6, there is a directed edge between the model 1 and the model 2, wherein model 1 is acting as the source node and model 2 is acting as the destination node. The execution of model 2 follows execution of model 1.

Model 1 and model 2 are independent of model 3 and model 4. Model 3 is independent of model 1, model 2 and model 4. Model 4 is independent of model 1, model 2 and model 3. Thus, there are no edges between model 1 and model 3, model 1 and model 4, model 2 and model 3, model 2 and model 4, and model 3 and model 4. The model dependency graph is used for managing the loading/unloading of the DNN models in the processing units.

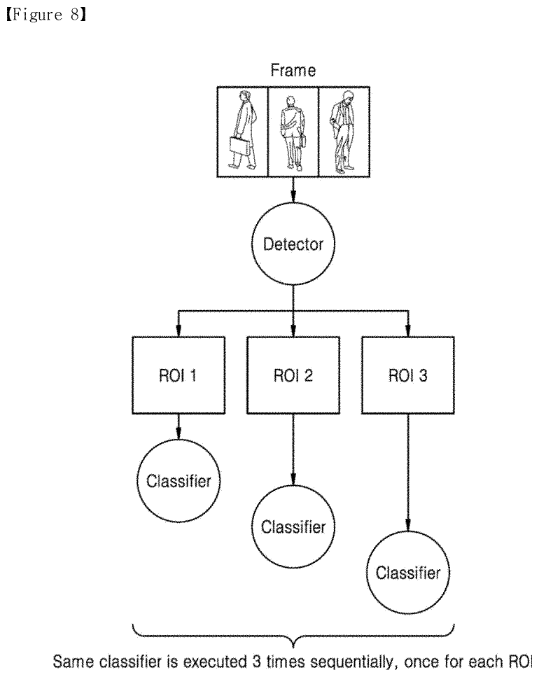

FIG. 7 is an example depicting the generation of a model dependency graph, indicating dependencies between four DNN models that are utilized by a camera application installed in the device 200, according to embodiments of the disclosure. The camera application can operate in the first mode and the version mode. When operating in the first mode, the first classifier and the first detector are executed. When operating in the second mode, the second classifier and second detector are executed. When there is a mode switch, the relevant classifier and detector are executed.

The model dependency analyzer 202 can determine the dependencies amongst the first classifier, the first detector, the second classifier and the second detector. The dependencies are amongst DNN models executed by the camera application. The first detector and the first classifier are executed in sequence. In the first mode, the first detector is executed first, followed by the first classifier. The edges of the model dependency graph specify the order in which the DNN models are supposed to be loaded. As the first detector and the first classifier are executed in sequence, the first classifier in loaded after loading the first detector. Therefore, there is a directed edge between the first detector and the first classifier, wherein the first detector represents the source node and the first classifier represents the destination node.

When there is a mode switch from first to second, the second detector and the second classifier are executed. The second detector and the second classifier are executed in sequence, i.e., the second detector is executed first and the second classifier is executed second. As the second detector and the second classifier are executed in sequence, the second detector is loaded first and the second classifier in loaded second. Therefore, there is a directed edge between the second detector and the second classifier, wherein the second detector represents the source node and the second classifier represents the destination node.

The first detector and the first classifier are executed independently of the second detector and the second classifier. Therefore, there is no dependency between the first detector and either of the second detector and second classifier. Similarly, there is no dependency between the first classifier and either of the second detector and second classifier. Thus, the model dependency graph comprises of two model dependency sub-graphs.

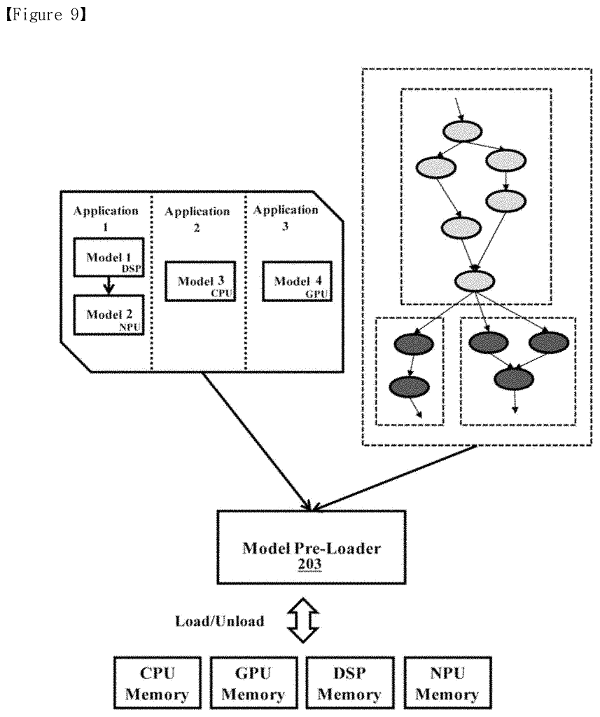

FIG. 8 is a use case scenario depicting sequential execution of a detector DNN model and a classifier DNN model, for detecting objects and classifying the detected objects in a Region of Interest (ROI) of a media captured by the camera application, according to embodiments of the disclosure. Consider that a frame is captured using the camera application. In both modes of the camera application, i.e., the scene detector mode and the Bixby second mode, the detector model (first or second) is executed on the frame to obtain at least one ROI in the frame. Consider that three ROIs have been obtained, wherein each ROI includes at least one detected object. After detecting the ROIs, the classifier model (first or second) is executed on each of the ROIs to classify the objects in each of the three ROIs.

A sequence of DNN inferences for the frame can be obtained. A single detector inference is followed by three classifier inferences (one for each ROI). The first classifier is dependent on the first detector and needs to be loaded after the first detector model has been loaded. Similarly, the second classifier is dependent on second detector model and needs to be loaded after the second detector model has been loaded. In addition to the above, the embodiments include collecting information pertaining to the order in which the classifiers and detectors are to be executed.

The embodiments allow re-usage of Input/output (I0) and internal Memory, previously used for execution of the detector models, for execution of the classifier model. The re-usage is enabled due to the information obtained using by the model dependency graph. For example, using the model dependency graph the embodiments can determine that the classifier is executed after executing the detector. Hence the detector and classifier models are not loaded at the same time, and if there is redundancy in the structures of the detector and classifier models, the non-redundant portion of the classifier is loaded. This enables an improvement in the efficiency of memory usage and latency of the device 200. It can be noted that the detector and the classifier models can be added at same time, but as the detector and the classifier models are executed sequentially, memory can be reused.

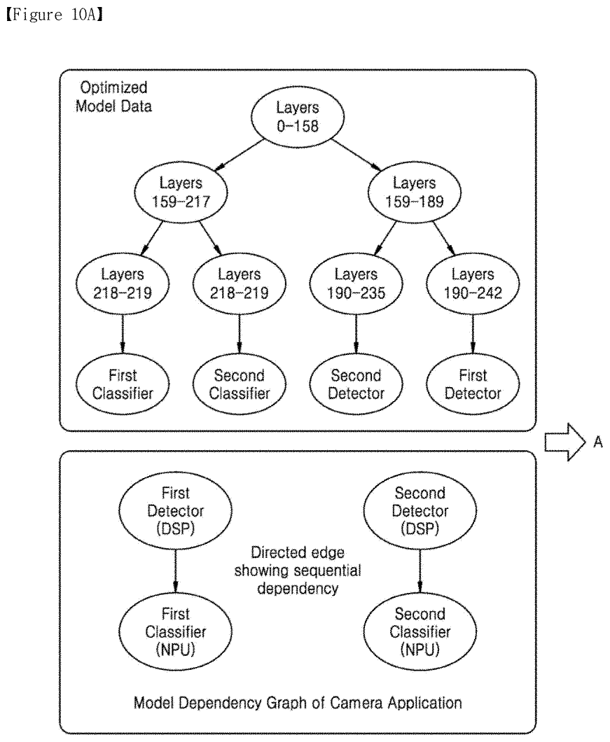

FIG. 9 is an example depicting preloading of DNN models in different processing units of the device 200 by the model pre-loader 203, according to embodiments of the disclosure. As depicted in FIG. 9, the model pre-loader 203 obtains the model dependency graph and the optimized model data. The model pre-loader 203 determines the available memory in each processing unit 204. Based on the model dependency graph, the optimized model data, and the available memory, the model pre-loader 203 can choose the layers of the DNN models that need to be preloaded. The model pre-loader 203 can decide whether to load/unload parts of the structures of the DNN models in the memories of each of the processing units 204, deciding the parts of the structures of the DNN models to be kept loaded/unloaded when a DNN model is unloaded/loaded, and the memory sharing between the DNN models loaded in the memory of the processing units 204.

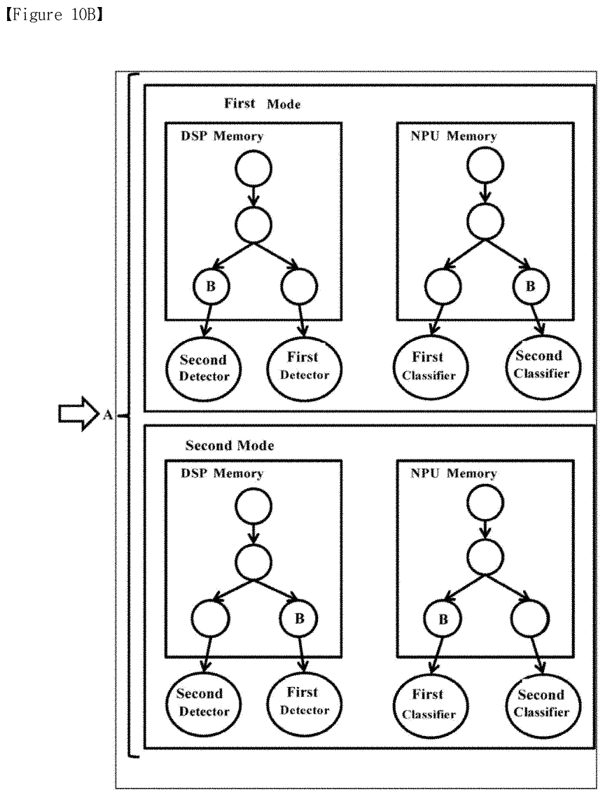

FIG. 10A and FIG. 10B are a use case scenario depicting the preloading/loading/unloading of DNN models used by the camera application based on model dependency graph and optimized model data, according to embodiments of the disclosure. The modes of operation of the camera application are the first mode, and the second mode. As depicted in FIGS. 10A and 10B, the model dependency graph pertaining to the execution of DNN models by the camera application and the optimized model data are used for determining the layers to be loaded when a model is executed, layers to be unloaded when the execution of the model is complete, and the layers of the model that need to be kept loaded after the execution of the model is complete. The gray blocks (labeled as B) need not be unloaded if sufficient memory is available to keep them loaded. Otherwise the blocks can be removed or unloaded to save memory so that other required blocks can be loaded.

Consider that the NPU and DSP share their respective internal memory. Consider that initially second mode was used. Therefore, second detector and second classifier can be loaded or unloaded in/from the DSP and NPU. The second detector is loaded on the DSP first, and based on the redundancy identified using the optimized model data, the specific area (comprising of the non-redundant layers) of the structure of the second classifier is loaded on the NPU after the execution of the second detector. The second detector and second classifier share a common area (layers 0-158). As the NPU and the DSP share their respective memories, the redundant layers need not be loaded again.

In another scenario, the second detector can be pre-loaded on the DSP and when the camera application is switched to the second mode, the specific area of the second classifier can be loaded on the NPU after the second detector has been executed (second detector had detected objects captured by the camera). If sufficient space is available in the memory DSP and/or NPU, then during the loading of the specific area of the second classifier, the specific area of the second detector need not be unloaded.

In yet another scenario, the second classifier can be pre-loaded on the NPU and when the camera application is switched to the second mode, the specific area of the second detector can be loaded on the DSP. If the sufficient space is available in the memory DSP and/or NPU, then during the loading of the specific area of the second detector, the specific area of the second classifier need not be unloaded.

When first mode is used, the first detector and the first classifier can be loaded or unloaded in/from the DSP and NPU. The first detector is loaded on the DSP first, and based on the redundancy identified using the optimized model data, the specific area (comprising of the non-redundant layers) of the structure of the first classifier is loaded on the NPU after the execution of the first detector. Based on the optimized model data, the specific area of the first detector is added. This is because the second classifier and the first detector share a common area (layers 0-217).

In another scenario, the first detector can be pre-loaded on the DSP and when the camera application is switched to the second mode, the specific area of the first classifier can be loaded on the NPU after the first detector has been executed. If the sufficient space is available in the memory DSP and/or NPU, then during the loading of the specific area of the first classifier in the NPU, the specific area of the first detector need not be unloaded from the DSP. It can be noted that the first detector and first classifier share a common area (layers 0-158).

In yet another scenario, the first classifier can be pre-loaded on the NPU and when the camera application is switched to the first mode, the specific area of the first detector can be loaded on the DSP. If the sufficient space is available in the memory DSP and/or NPU, then during the loading of the specific area of the first detector in the DSP, the specific area of the first classifier need not be unloaded from the NPU.

The embodiments allow improved memory utilization during the preloading. The embodiments facilitate preloading multiple DNN models while using slightly higher memory as needed for loading a single DNN model.

The embodiments disclosed herein can be implemented through at least one software program running on at least one hardware device and performing network management functions to control the network elements. The network elements shown in FIG. 2 include blocks which can be at least one of a hardware device, or a combination of hardware device and software module.

The embodiments disclosed herein describe methods and systems for deployment of Deep Neural Network (DNN) models in a device based on redundant layers in different DNN models and dependency amongst the DNN models. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in example Very high speed integrated circuit Hardware Description Language (VHDL) another programming language, or implemented by one or more VHDL or several software modules being executed on at least one hardware device. The hardware device can be any kind of portable device that can be programmed. The device may also include means, which could be, for example, a hardware means, for example, an Application-specific Integrated Circuit (ASIC), or a combination of hardware and software means, for example, an ASIC and a Field Programmable Gate Array (FPGA), or at least one microprocessor and at least one memory with software modules located therein. The method embodiments described herein could be implemented partly in hardware and partly in software. Alternatively, the disclosure may be implemented on different hardware devices, e.g. using a plurality of Central Processing Units (CPUs).

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as acritical, required, or essential feature or component of any or all the claims.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A method of managing deep neural network (DNN) models on a device, the method comprising:
extracting information associated with each of a plurality of DNN models;
identifying, from the information, common information which is common across the plurality of DNN models;
separating and storing the common information into a designated location in the device; and
controlling at least one DNN model among the plurality of DNN models to access the common information.

2. The method of claim 1, wherein the information associated with each of the plurality of DNN models comprises parameters and structures of each of the plurality of DNN models.

3. The method of claim 1, further comprising:
pre-loading a subset of the common information based on a pre-loadable memory capacity of the device.

4. The method of claim 3 further comprising:
determining, among the plurality of DNN models, dependent models associated with each application installed on the device,
wherein the dependent models comprise at least one of a model required to run with another model among the plurality of DNN models at the same time and a model with a fixed order of execution in relation to another model among the plurality of DNN models.

5. The method of claim 4 wherein the model with the fixed order of execution in relation to another model among the plurality of DNN models comprises at least one of:
a model to be executed serially in relation to another model among the plurality of DNN models; and
a model to be executed in parallel with another model among the plurality of DNN models.

6. An apparatus for managing Deep Neural Network (DNN) models, the apparatus comprising:
a memory; and
a processor configured to
identify redundancy in structures of at least two DNN models based on a presence of at least one layer in the at least two DNN models,
determine, among the at least two DNN models, dependency which specifies a pattern of executing the at least two DNN models, and
deploy the at least two DNN models based on the redundancy and the dependency of the at least two DNN models.

7. The apparatus of claim 6, wherein the deploying of the at least two DNN models is performed further based on an availability of capacity of the memory.

8. The apparatus of claim 6, wherein the presence of the at least one layer in the at least two DNN models is detected based on at least one reference count value associated with the at least one layer in the structures of the at least two DNN models,
wherein the reference count is initialized during an initial traversal of the structures of the at least two DNN models.

9. The apparatus of claim 8, wherein the at least one reference count value associated with the at least one layer is incremented when the at least one layer is traversed in the at least two DNN models, wherein the at least one layer in the at least two DNN models contributes to the redundancy in the structures of at least two DNN models.

10. The apparatus of claim 9, wherein the processor is configured to a layer is determined to contribute the redundancy in the structures when the reference count value associated with the layer is incremented.

11. The apparatus of claim 9, wherein the processor is configured to pre-load at least one layer contributing to the redundancy prior to the execution of the at least two DNN models.

12. The apparatus of claim 6, wherein the pattern of executing the at least two DNN models comprises
executing the at least two DNN models by an application in sequence; and
executing the at least two DNN models by an application in parallel.

13. The apparatus of claim 6, wherein the processor is configured to pre-load layers of the at least two DNN models based on the redundancy and the dependency of the at least two DNN models.

14. The apparatus of claim 13, wherein the processor is configured to assign priorities to each of layers of the at least two DNN models based on a reference count values associated with the layers of the at least two DNN models, and wherein the pre-loading of the at least two DNN models are further based on the assigned priorities.

15. The apparatus of claim 6, wherein the processor is configured to determine reference count values associated with all the layers of the at least two DNN models, compare each of the at least two DNN models based on the reference count values.
